(19) United States
(12) Patent Application Publication
(10) Pub. No.: US 2025/0273804 A1
(43) Pub. Date: Aug. 28, 2025

(54) SECONDARY BATTERY AND BATTERY MODULE INCLUDING SECONDARY BATTERY

(71) Applicant: SK On Co., Ltd., Seoul (KR)

(72) Inventors: Hye Been SON, Daejeon (KR); Won Tae HEO, Daejeon (KR)

(21) Appl. No.: 18/818,589

(22) Filed: Aug. 29, 2024

(30) Foreign Application Priority Data
Feb. 22, 2024 (KR) 10-2024-0025430

(51) Int. Cl. H01M 50/342; H01M 50/505; H01M 50/60

(52) U.S. Cl. CPC H01M 50/3425; H01M 50/505; H01M 50/668

(57) ABSTRACT

A secondary battery and a battery module including the same are disclosed. In some implementations, the secondary battery may include an electrode assembly including a negative electrode plate, a positive electrode plate, and a separator interposed between the negative electrode plate and the positive electrode plate, a case accommodating the electrode assembly, a vent portion positioned on a plate disposed on one side of the case, the vent portion including a notch portion configured to be breakable; and a leakage prevention portion disposed further outwardly than the vent portion, the leakage prevention portion coupled to the plate on which the vent portion is positioned. The leakage prevention portion may include a leakage prevention layer disposed to oppose the vent portion, a body portion disposed between the leakage prevention layer and the vent portion, the body portion having an opening.

### CROSS-REFERENCE TO RELATED APPLICATION(S)

This patent document claims the priority and benefits of Korean Patent Application No. 10-2024-0025430 filed on Feb. 22, 2024, the disclosure of which is incorporated herein by reference in its entirety.

### TECHNICAL FIELD

The disclosure and implementations disclosed in this patent document relate to a secondary battery and a battery module including the same.

### BACKGROUND

A secondary battery may be a type of energy storage means that may be charged and discharged. Secondary batteries have been widely used in a variety of electricity-powered devices. For example, secondary batteries have used been as an energy storage means in applications ranging from small devices such as cellphones, laptops, tablets, and the like to large devices such as vehicle, aircraft, and the like. Recently, secondary batteries have been actively researched for use as a vehicle power source.

Secondary batteries may be categorized into lead-acid batteries, nickel-cadmium batteries, nickel-hydrogen batteries, lithium-ion batteries, and the like, depending on an electrode material. A type of secondary battery may be selected depending on a design capacity, a usage environment, or the like. Alternatively, a secondary battery may be an all-solid-state battery using a solid electrolyte instead of a liquid electrolyte. Li-ion batteries may have relatively high voltages and capacitance, as compared to other types of secondary batteries. As a result, Li-ion batteries have been widely used in devices within fields, requiring high-density energy storage means, such as vehicle battery packs or the like.

A secondary battery, such as a lithium-ion battery, may include a positive electrode, a negative electrode, a separator, and an electrolyte. The positive electrode and the negative electrode may be disposed with the separator formed of an insulating material interposed therebetween, and may be charged or discharged by the movement of ions through the electrolyte.

Secondary batteries may be manufactured as flexible pouch-type battery cells or rigid prismatic or cylindrical can-type battery cells.

### SUMMARY

When internal pressure of a secondary battery increases, gas may be discharged through a vent portion formed in a case. During a process of discharging gas, an electrolyte may be discharged together therewith. The discharged electrolyte may affect devices surrounding the secondary battery, and thus it may be necessary to prevent discharge of the electrolyte.

According to an aspect of the present disclosure, leakage of an electrolyte may be prevented when gas is discharged from a secondary battery.

According to an aspect of the present disclosure, a secondary battery may have improved stability and safety.

According to an aspect of the present disclosure, a battery module may have improved stability and safety.

A secondary battery and a battery module of the present disclosure may be widely applied in the field of green technology, such as to electric vehicles, battery charging stations, and other battery-utilizing solar power generation schemes, wind power generation schemes, or the like. In addition, the secondary battery and the battery module of the present disclosure, may be used in eco-friendly electric vehicles, hybrid vehicles, and the like, to prevent climate change by suppressing air pollution and greenhouse gas emissions.

In some embodiments of the present disclosure, a secondary battery may include an electrode assembly including a negative electrode plate, a positive electrode plate, and a separator interposed between the negative electrode plate and the positive electrode plate, a case accommodating the electrode assembly, a vent portion positioned on a plate disposed on one side of the case, the vent portion including a notch portion configured to be breakable; and a leakage prevention portion disposed further outwardly than the vent portion, the leakage prevention portion coupled to the plate on which the vent portion is positioned. The leakage prevention portion may include a leakage prevention layer disposed to face the vent portion, a body portion disposed between the leakage prevention layer and the vent portion, the body portion having an opening.

In an embodiment, the leakage prevention layer may have a porous structure.

In an embodiment, the leakage prevention layer may be disposed to be spaced apart from the vent portion by a first distance in a first direction. The first direction may be a direction, perpendicular to one surface of the vent portion.

In an embodiment, a flat section of the leakage prevention layer may have an area, equal to or greater than an area of a flat section of the vent portion.

In an embodiment, a flat section of the vent portion may have an oval shape. A flat section of the leakage prevention layer may have an oval shape.

In an embodiment, the first distance may be equal to or greater than half a second distance. The second distance may be a length of a short axis of the flat section of the vent portion.

In an embodiment, the leakage prevention layer may be configured to allow gas, discharged from the vent portion, to pass therethrough, and to not allow liquid, discharged from the vent portion, to pass therethrough.

In an embodiment, the body portion may have a tube shape.

In an embodiment, the body portion may have a shape gradually widening from the leakage prevention layer to the vent portion.

In an embodiment, the leakage prevention portion may include a fixing portion protruding along a perimeter of the body portion.

In an embodiment, the fixing portion may be coupled to and fixed to the plate on which the vent portion is positioned.

In an embodiment, a plurality of openings may be disposed along a perimeter of the body portion.

In an embodiment, the openings may be disposed in a distributed manner along the perimeter of the body portion.

In an embodiment, the body portion may have a first region in which the openings are positioned along the perimeter, and a second region in which the openings are not positioned.

In another embodiment, the first region may be disposed to face one of side surfaces of the case.

In another embodiment, the leakage prevention layer may be formed as a plate configured to prevent gas and liquid from passing therethrough. The opening may have a porous structure.

In some embodiments of the present disclosure, a battery module may include a plurality of secondary batteries, a housing accommodating the plurality of secondary batteries, and a busbar assembly electrically connecting the plurality of secondary batteries to each other. The plurality of secondary batteries may include an electrode assembly including a negative electrode plate, a positive electrode plate, and a separator interposed between the negative electrode plate and the positive electrode plate, a case accommodating the electrode assembly, a vent portion positioned on a plate disposed on one side of the case, the vent portion including a notch portion configured to be breakable, and a leakage prevention portion disposed further outwardly than the vent portion, the leakage prevention portion coupled to the plate on which the vent portion is positioned. The leakage prevention portion may include a leakage prevention layer disposed to face the vent portion, and a body portion disposed between the leakage prevention layer and the vent portion, the body portion having an opening.

According to an embodiment of the present disclosure, leakage of electrolyte may be prevented when gas is discharged from a secondary battery.

According to an embodiment of the present disclosure, a secondary battery may have improved stability and safety.

According to an embodiment of the present disclosure, a battery module may have improved stability and safety.

According to an embodiment of the present disclosure, a secondary battery and a battery module may be widely applied in the field of green technology, such as to electric vehicles, battery charging stations, and other battery-utilizing solar power generation schemes, wind power generation schemes, or the like. In addition, according to an embodiment of the present disclosure, the secondary battery and the battery module may be used in eco-friendly electric vehicles, hybrid vehicles, and the like, to prevent climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a perspective view of a secondary battery according to the present disclosure.

FIG. 2 is a cross-sectional view taken along line I-I′ of FIG. 1.

FIG. 3 is an enlarged cross-sectional view of portion A of FIG. 2.

FIG. 4 is an enlarged cross-sectional view of a state in which gas is discharged from a secondary battery.

FIG. 5 is a cross-sectional view of a leakage prevention portion.

FIG. 6 is a plan view of a portion of an top portion of a secondary battery according to the present disclosure.

FIG. 7 is a plan view of a vent portion.

FIG. 8 is a plan view of a modification of a body portion.

FIG. 9 is a perspective view of another modification of a body portion.

FIG. 10 is a perspective view of another modification of a leakage prevention portion.

FIG. 11 is a cross-sectional view of a modification of a secondary battery according to the present disclosure.

FIG. 12 is a perspective view of a battery module according to the present disclosure.

### DETAILED DESCRIPTION

Hereinafter, embodiments of the present disclosure will be described with reference to the attached drawings. For convenience, in the following description, detailed descriptions will be omitted for configurations that obscure the technical gist of the present disclosure or for known configurations.

The following embodiments are provided to more completely describe the present disclosure to those skilled in the art. The following embodiments are provided to aid understanding of the present disclosure, and the technical idea of the present disclosure is not necessarily limited to particular embodiments described below. The present disclosure should be understood to broadly include all changes, equivalents, and replacements within the idea and the technical scope of the disclosure.

The terms used herein are provided to more completely describe specific embodiments from the above-described point of view. Accordingly, the terms used herein should not be construed to reduce, limit, or restrict the technical idea of the present disclosure.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

A secondary battery or a battery cell, described herein, may include a battery that may be charged and discharged. For example, the secondary battery may include a lead acid battery, a nickel cadmium battery, a nickel hydride battery, a lithium-ion battery, and the like. In this description, it is mainly assumed that the secondary battery is a lithium-ion battery. However, it should be understood that a technical concept described herein are applicable to other suitable types of batteries other than a lithium-ion battery.

The words and terminologies used in the specification and claims should not be construed with common or dictionary meanings, but construed as meanings and conception coinciding the spirit of the present disclosure under a principle that the inventor(s) may appropriately define the conception of the terminologies to explain the present disclosure in the optimum method. Therefore, embodiments described in the specification and the configurations illustrated in the drawings are not more than the most preferred embodiments of the present disclosure and do not fully cover the spirit of the present disclosure. Accordingly, it should be understood that there may be various equivalents and modifications that may replace those when the present application is filed.

Hereinafter, preferred embodiments of the present disclosure will be described in detail with reference to the accompanying drawings. In this case, it should be noted that the same components are denoted by the same reference numerals in the accompanying drawings. In addition, detailed descriptions of well-known functions and configurations that may obscure the gist of the present disclosure will be omitted. In addition, some components are exaggerated, omitted, or schematically illustrated in the accompanying drawings, and the size of each component does not fully reflect the actual size. In addition, as used herein, terms such as “top side,” “top portion,” “top surface,” “bottom side,” “bottom portion,” “bottom surface,” and “side surface” are based on the drawings, may vary depending on a direction in which an element or component is actually arranged.

Hereinafter, a secondary battery and a battery module including the same according to the present disclosure will be described in detail with reference to the drawings.

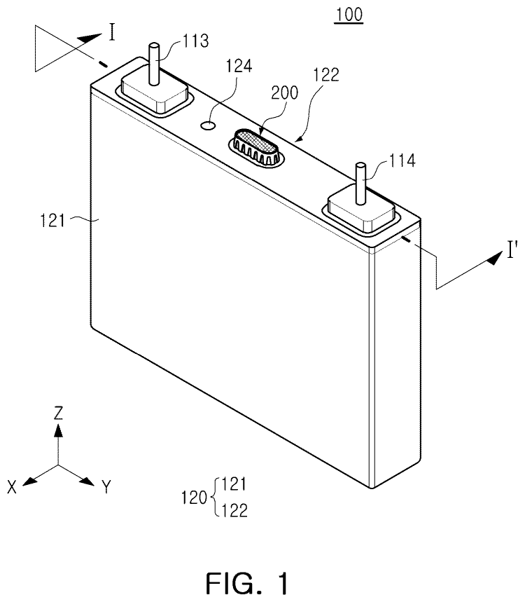

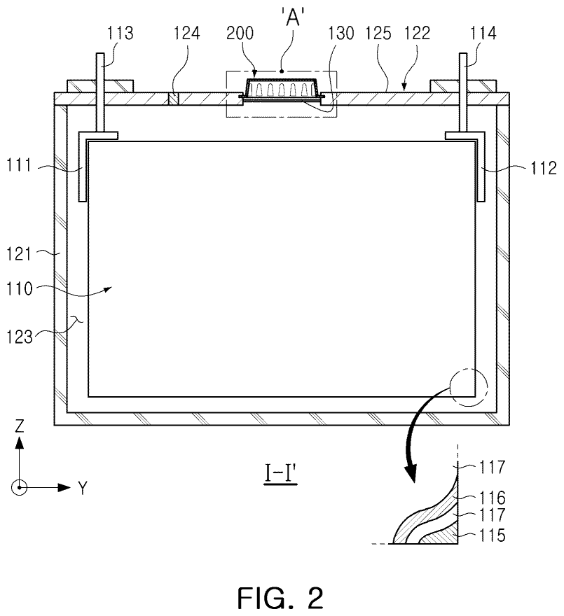

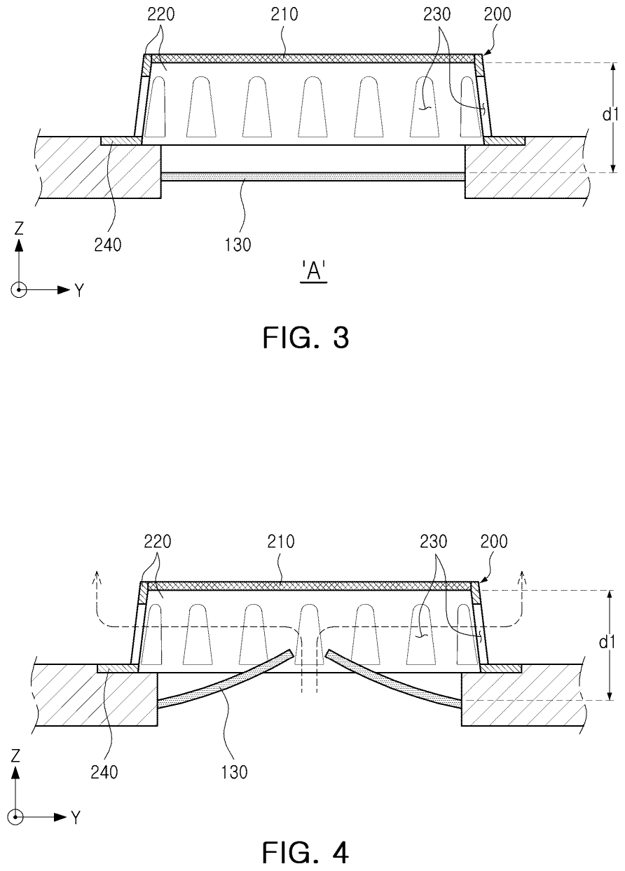

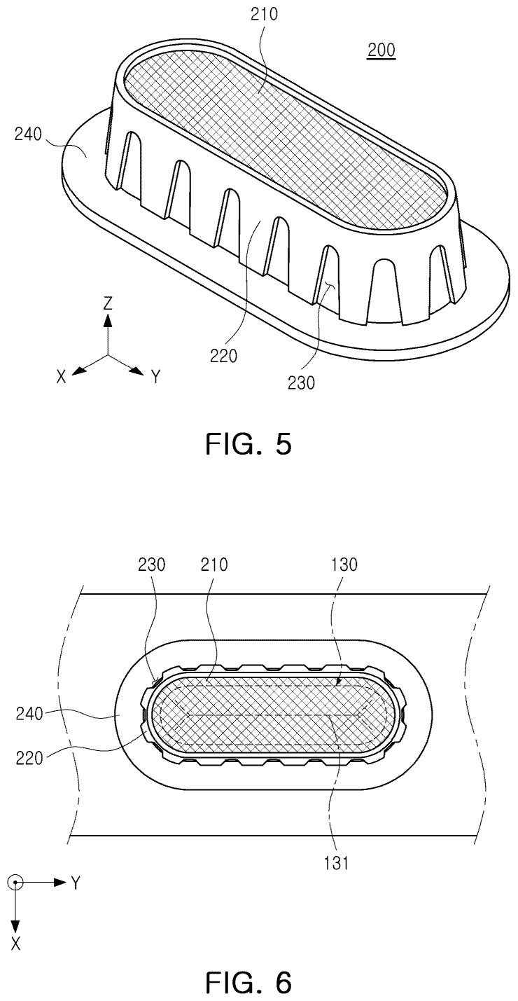

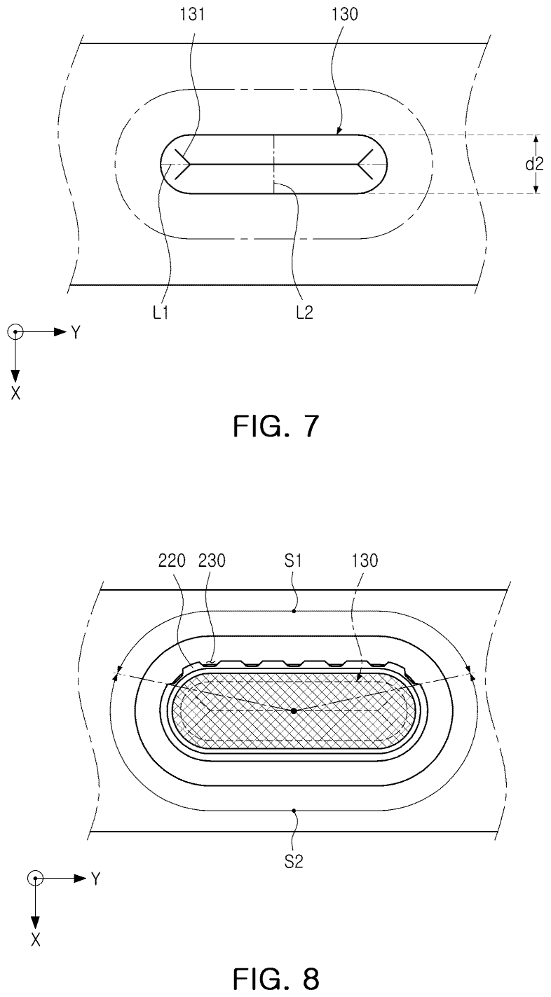

FIG. 1 is a perspective view of a secondary battery 100 according to the present disclosure. FIG. 2 is a cross-sectional view taken along line I-I′ of FIG. 1. FIG. 3 is an enlarged cross-sectional view of portion A of FIG. 2. FIG. 4 is an enlarged cross-sectional view of a state in which gas is discharged from the secondary battery 100. FIG. 5 is a cross-sectional view of a leakage prevention portion 200. FIG. 6 is a plan view of a portion of an top portion of the secondary battery 100 according to the present disclosure. FIG. 7 is a plan view of a vent portion 130.

Referring to FIGS. 1 to 7, the secondary battery 100 may include an electrode assembly 110, a case 120, a vent portion 130, and a leakage prevention portion 200.

The secondary battery 100 may include the electrode assembly 110 including a negative electrode plate 115, a positive electrode plate 116, and a separator 117 interposed between the negative electrode plate 115 and the positive electrode plate 116, the case 120 accommodating the electrode assembly 110, the vent portion 130 positioned on a plate disposed on one side of the case 120, the vent portion 130 including a notch portion 131 configured to be breakable and the leakage prevention portion 200 disposed further outwardly than the vent portion 130, and the leakage prevention portion 200 coupled to the plate on which the vent portion 130 is positioned.

In addition, the leakage prevention portion 200 may include a leakage prevention layer 210 disposed to face the vent portion 130 and a body portion 220 disposed between the leakage prevention layer 210 and the vent portion 130, and the body portion 220 may have an opening 230.

The electrode assembly 110 may include an electrode plate and a separator 117. The electrode plate may include a positive electrode plate 116 and a negative electrode plate 115. The separator 117 may be configured as an insulator interposed between the negative electrode plate 115 and the positive electrode plate 116. The electrode assembly 110 may include a negative electrode plate 115, a positive electrode plate 116, and a separator 117 interposed between the negative electrode plate 115 and the positive electrode plate 116. For example, the electrode assembly 110 may be configured as an assembly-type electrode assembly in which the negative electrode plate 115, the positive electrode plate 116, and the separator 117, interposed between the negative electrode plate 115 and the positive electrode plate 116, are alternately stacked or arranged. Alternatively, the electrode assembly 110 may be configured as a jelly roll-type electrode assembly in which the negative electrode plate 115, the positive electrode plate 116, and the separator 117, interposed between the negative electrode plate 115 and the positive electrode plate 116, are alternately stacked or arranged and wound in the form of a roll.

The case 120 may accommodate the electrode assembly 110. For example, the case 120 may have an accommodation space 123 therein. The accommodation space 123 may be a space accommodating the electrode assembly 110.

The case 120 may include a can 121 and a cap plate 122. The can 121 may have an opening formed in one side thereof. The can 121 may have a rectangular parallelepiped shape. However, the shape of the case 120 is only an example, and is not necessarily limited to the rectangular parallelepiped shape. The cap plate 122 may seal the opening formed in the one side of the can 121. For example, the cap plate 122 may be coupled to cover the opening of the can 121. The cap plate 122 may be coupled to the can 121 to seal the opening. Accordingly, after the electrode assembly 110 is accommodated in the accommodation space 123 formed in the can 121, the cap plate 122 may be coupled to the can 121 to seal the accommodation space 123.

The electrode assembly 110 may be electrically connected to an electrode terminal. The electrode terminal may include a first electrode terminal 113 and a second electrode terminal 114. The first electrode terminal 113 and the second electrode terminal 114 may be electrically connected to the electrode assembly 110. For example, the first electrode terminal 113 and the second electrode terminal 114 may be electrically connected to the positive electrode plate 116 and the negative electrode plate 115, respectively. The positive electrode plate 116 and the negative electrode plate 115 may be electrically connected to the first electrode terminal 113 and the second electrode terminal 114 through a first lead tab 111 and a second lead tab 112, respectively. At least a portion of the first electrode terminal 113 and the second electrode terminal 114 may be exposed to the outside of the case 120. For example, the first electrode terminal 113 and the second electrode terminal 114 may pass through the cap plate 122. Accordingly, at least a portion of the first electrode terminal 113 and the second electrode terminal 114 may protrude toward an top portion of the cap plate 122.

The first lead tab 111 may electrically connect the positive electrode plate 116 of the electrode assembly 110 and the first electrode terminal 113 to each other. The first lead tab 111 may include a metal material having electrical conductivity. The first lead tab 111 may be welded or bonded to each of the electrode assembly 110 and the first electrode terminal 113, such that electricity may flow through the first lead tab 111.

One end of the first lead tab 111 may be electrically connected to the electrode assembly 110, and the other end of the first lead tab 111 may be electrically connected to the first electrode terminal 113. For example, the first lead tab 111 may have a bent long bar shape. A bottom portion of the first lead tab 111 may be electrically connected to the positive electrode plate 116, and an top portion of the first lead tab 111 may be connected to the first electrode terminal 113. However, the shape of the first lead tab 111 is only an example, and may be appropriately changed within the scope of achieving the purpose of the present disclosure.

The second lead tab 112 may be a component electrically connect the electrode assembly 110 and the second electrode terminal 114 to each other. A shape of the second lead tab 112 may be similar to that of the first lead tab 111. One end of the second lead tab 112 may be electrically connected to the electrode assembly 110, and the other end of the second lead tab 112 may be electrically connected to the second electrode terminal 114.

The cap plate 122 may have an electrolyte injection hole 124. The electrolyte injection hole 124 may be a hole passing through the cap plate 122. An electrolyte may be injected into the can 121 through the electrolyte injection hole 124. The electrolyte injection hole 124 may be sealed using a stopper or the like after the electrolyte is injected.

The vent portion 130, configured to discharge gas into the case 120, may be positioned on the case 120. For example, the vent portion 130 may be positioned on a plate disposed on one side of the case 120. The plate on which the vent portion 130 is positioned may be one of several plates of the case 120. For example, the plate on which the vent portion 130 is positioned may be the cap plate 122. Alternatively, the plate on which the vent portion 130 is positioned may be a plate positioned on a side surface or a bottom portion of the can 121. As described above, the plate on which the vent portion 130 is positioned may be a plate oriented in any direction of the case 120, and is not necessarily limited to the position illustrated in the drawings.

The vent portion 130 may include a notch portion 131 configured to be breakable. The notch portion 131 may be a thin portion formed in the vent portion 130. For example, the vent portion 130 may be configured as a thin plate, and may be coupled to the plate on which the vent portion 130 of the case 120 is positioned, using welding or the like. In this case, the plate on which the vent portion 130 is positioned may have a hole formed in advance, such that the vent portion 130 may be coupled thereto. The notch portion 131 may be a portion of the vent portion 130, formed of a thinner material or another material that is prone to breakage. The notch portion 131 may have weak rigidity than other portions of the vent portion 130. That is, at a pressure higher than or equal to a pressure set for the vent portion 130 to break, the notch portion 131 may break before the other portions of the vent portion 130. A shape of the notch portion 131 may vary, and is not necessarily limited to the shape of the notch 131 illustrated in the drawings.

The leakage prevention portion 200 may be configured to discharge gas discharged from the vent portion 130, and to prevent liquid from being discharged. The leakage prevention portion 200 may be disposed further outwardly than the vent portion 130. “Outwardly” referred to herein may be a direction toward the outside of the case 120. Conversely, the accommodation space 123 may be positioned in the case 120. The leakage prevention portion 200 may be disposed at a position relatively farther from the accommodation space 123 than the vent portion 130. For example, the accommodation space 123, the vent portion 130, and the leakage prevention portion 200 may be disposed from the inside to the outside of the case 120.

The leakage prevention portion 200 may include a leakage prevention layer 210 and a body portion 220.

The leakage prevention layer 210 may be disposed to face the vent portion 130. For example, the leakage prevention layer 210 may be configured as a thin film or a plate. The leakage prevention layer 210 may be configured as a thin layer, and may have a surface. At least one surface of the leakage prevention layer 210 may face at least one surface of the vent portion 130. The leakage prevention layer 210 may be positioned further outwardly than the vent portion 130 in a state of facing the vent portion 130.

The leakage prevention layer 210 may have a porous structure. For example, the leakage prevention layer 210 may have a mesh structure. The leakage prevention layer 210 may ensure air permeability through the porous structure.

The leakage prevention layer 210 may be configured to allow gas discharged from the vent portion 130 to pass therethrough, and to not allow liquid to pass therethrough. When gas is discharged from the vent portion 130, an electrolyte, accommodated in the case 120, may also be discharged from the vent portion 130. The electrolyte may include a material having high ionic conductivity or a highly acidic material. Accordingly, when the electrolyte is completely discharged to the outside of the secondary battery 100, a chemical reaction may occur with other secondary batteries 100 or devices positioned on the outside of the secondary battery 100. A hole having a porous structure may have a large size sufficient to externally discharge gas. However, the size may be small to discharge liquid. For example, the leakage prevention layer 210 may include a membrane. The membrane may be an ultra-thin film manufactured by stretching expanded Polytetrafluoroethylene (e-PTFE) under specific conditions. A hole of the membrane, having a porous structure, may have a large size sufficient to externally discharge gas. However, the size may be small to discharge liquid.

The leakage prevention layer 210 may be disposed to be spaced apart from the vent portion 130 by a first distance d1 in a first direction Z. The first direction Z may be a direction, perpendicular to one surface of the vent portion 130. Specifically, the leakage prevention layer 210 may be disposed on the outside of the case 120 than the vent portion 130 in the first direction Z. Accordingly, gas or liquid, discharged from the vent portion 130, may be in a certain space positioned between the leakage prevention layer 210 and the vent portion 130. The first direction Z may change depending on a position of the vent portion 130. For example, when the vent portion 130 is positioned on a side surface of the can 121 in an X-axis direction or a Y-axis direction, the first direction Z may also be the X-axis direction or Y-axis direction. That is, the first direction Z is not necessarily limited to the Z-axis direction illustrated in the drawings. The first distance d1 may be a distance between the leakage prevention layer 210 and the vent portion 130.

An area of a flat section of the leakage prevention layer 210 may be equal to or greater than an area of a flat section of the vent portion 130. The flat section may be a section of the leakage prevention layer 210 or the vent portion 130 in top view. For example, in top view, the vent portion 130 may be positioned on the inside of a region of the leakage prevention layer 210. However, the present disclosure is not limited thereto, and the flat section of the leakage prevention layer 210 may be formed to be smaller than the flat section of the vent portion 130 within the scope of achieving the purpose of the present disclosure.

The flat section of the vent portion 130 may have an oval shape, and the flat section of the leakage prevention layer 210 may have an oval shape. The oval shape referred to herein may also include an oval shape having a straight line. For example, the flat section of the vent portion 130 may have top and bottom portions having a straight line, and left and right sides having a round semicircular shape. The flat section of the leakage prevention layer 210 may have a shape similar to that of the vent portion 130. For example, the flat section of the leakage prevention layer 210 may be an enlarged shape of the flat section of the vent portion 130.

The first distance d1 may be appropriately adjusted depending on a size of the vent portion 130, a shape of the notch portion 131, or the like. For example, the first distance d1 may be equal to or greater than half a second distance d2. The second distance d2 may be a length of a short axis L2 of the flat section of the vent portion 130. When the flat section of the vent portion 130 has an oval shape, the flat section may have a short axis L2 and a long axis L1. The long axis L1 may be a long virtual line connecting central points of left and right edges, among edges of the vent portion 130, to each other, and the short axis L2 may be a virtual line connecting central points of top and bottom edges, among the edges of the vent portion 130, to each other. The flat section of the vent portion 130 may be symmetrical about the long axis LI or the short axis L2. In this case, a length of the short axis L2 may be defined as the second distance d2.

At least a portion of the vent portion 130 may be upwardly tilted when the notch portion 131 is broken by gas pressure. In this case, it may be necessary to maintain an appropriate distance such that a portion of the vent portion 130 does not hit the leakage prevention layer 210, positioned thereabove. For example, when the notch portion 131 is formed along the long axis L1 of the vent portion 130, a height at which the vent portion 130 is tilted may be half of the second distance d2. Accordingly, the first distance d1 may be at least half of the second distance d2. However, the first distance d1 may be adjusted depending on a shape of the notch portion 131 or a degree to which the vent portion 130 is tilted, and is not limited thereto.

The body portion 220 may be disposed between the leakage prevention layer 210 and the vent portion 130. For example, the leakage prevention layer 210 and the vent portion 130 may be disposed to be spaced apart from each other in a state of opposing each other. The body portion 220 may be disposed in a space between the leakage prevention layer 210 and the vent portion 130. The body portion 220 may be coupled to the leakage prevention layer 210 and formed integrally with the leakage prevention layer 210. For example, the body portion 220 may have a form in which a circumference or perimeter of the leakage prevention layer 210 extends in a direction of the vent portion 130.

Specifically, the body portion 220 may have a tube shape. The tube shape may have an empty space through which gas or liquid flows, and may be a shape including a wall surrounding the empty space. The body portion 220 may have an internal empty space to allow gas or liquid to pass therein. For example, gas or liquid, discharged from the vent portion 130, may move to the internal empty space of the body portion 220.

The body portion 220 may have a shape gradually widening from the leakage prevention layer 210 to the vent portion 130. For example, the flat section of the body portion 220 may have a narrow top portion and a wide bottom portion. Referring to FIG. 3, a side section of the body portion 220 may have a shape similar to a trapezoidal shape. The flat cross section may be a section of the body portion 220 in top view, and the side section may be a section of the body portion 220 in side view. The body portion 220 may have a wide bottom portion, and may be stably coupled to the case 120. In addition, a volume of the leakage prevention portion 200, protruding toward the outside of the case 120, may be reduced, thereby efficiency of a space of a secondary battery. However, the shape of the body portion 220 described above is only an example. Accordingly, the top portion and the bottom portion of the body portion 220 may be formed to have the same sectional area. Conversely, the top portion may be formed to have a sectional area, greater than that of the bottom portion.

The leakage prevention portion 200 may be coupled to a plate on which the vent portion 130 is positioned. The leakage prevention portion 200 may receive force due to gas discharged from the vent portion 130. Accordingly, the leakage prevention portion 200 may be fixed to and coupled to the plate on which the vent portion 130 is positioned, and thus may not be separated from the case 120.

The leakage prevention portion 200 may include a fixing portion 240. The fixing portion 240 may protrude along a perimeter of the body portion 220. For example, the fixing portion 240 may be in the form of one end of the body 220 protruding outwardly from the body 220. The fixing portion 240 may protrude in all directions of the perimeter of the body portion 220. The fixing portion 240 and the body portion 220 may form a certain angle. The leakage prevention portion 200 may have a shape similar to a shape of a hat. Referring to FIG. 5, a direction in which the fixing portion 240 protrude may be the same as a direction of a plane of the leakage prevention layer 210. The direction in which the fixing portion 240 protrudes and the angle, formed by the fixing portion 240 and the body portion 220, are not limited, and the fixing portion 240 may be appropriately changed within the scope in which the fixing portion 240 is inserted into and coupled to the plate on which the vent portion 130 is positioned.

The fixing portion 240 may be coupled to the plate on which the vent portion 130 is positioned to be fixed to the plate on which the vent portion 130 is positioned. The fixing portion 240 may have a sufficiently large area to be coupled to the plate on which the vent portion 130 is positioned. The fixing portion 240 may be inserted into the plate on which the vent portion 130 is positioned, and may be coupled to the plate on which the vent portion 130 is positioned using a method such as welding. A groove having a shape, corresponding to a shape of the fixing portion 240, may be formed in advance in the plate on which the vent portion 130 is positioned, such that the fixing portion 240 may be inserted into the groove. The fixing portion 240 may be inserted into the groove and then coupled to the groove using a method such as welding.

The body portion 220 may have an opening 230. The opening 230 may be a hole formed in the body 220. Gas, discharged from the vent portion 130, may also be discharged through the opening 230. A shape, a quantity, and a direction of the openings 230 may be formed in various manners.

For example, a plurality of openings 230 may be disposed along the perimeter of the body portion 220. Specifically, the openings 230 may be disposed in a distributed manner along the perimeter of the body portion 220. The plurality of openings 230 may be disposed at regular intervals. In this case, gas, discharged from the vent portion 130, may be discharged through the opening 230, and may be evenly spread. A pressure or an amount of the discharged gas may be divided and reduced through several openings 230.

Gas, discharged from the vent portion 130, may be in contact with the leakage prevention layer 210 corresponding to a primary discharge direction. At least a portion of gas may be discharged through the leakage prevention layer 210, and may be secondarily discharged in a distributed manner through the opening 230. The dotted arrow illustrated in FIG. 4 indicates a path through which gas is discharged. In this case, an electrolyte that may be discharged together with gas through the vent portion 130 may not pass through the leakage prevention layer 210, and may be blocked. Accordingly, the leakage prevention layer 210 may prevent the electrolyte from being discharged out of the secondary battery 100. In this case, a small amount of electrolyte may be discharged through the opening 230.

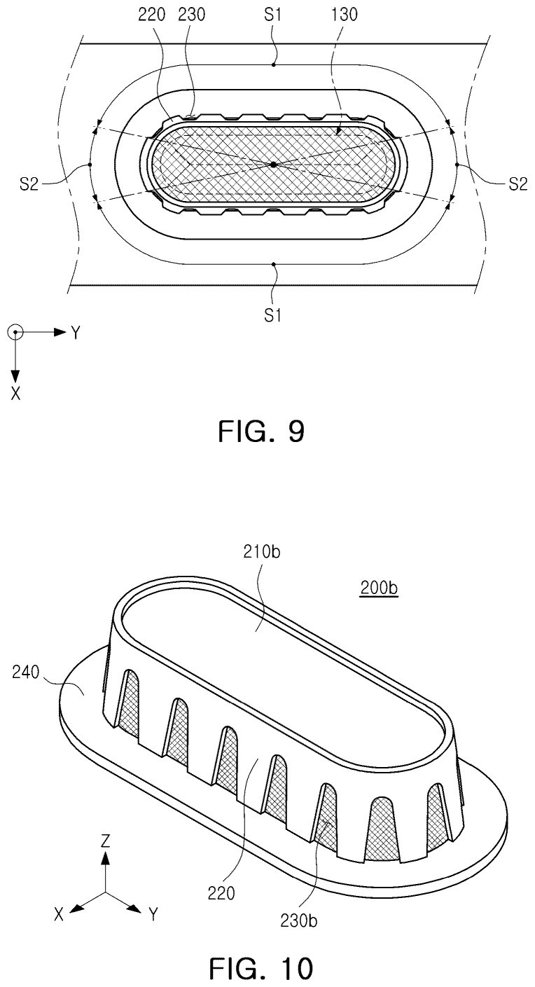

FIG. 8 is a plan view of a modification of the body portion 220. FIG. 9 is a perspective view of another modification of the body portion 220.

Referring to FIGS. 8 and 9, an opening 230 may be disposed in a certain region.

The body portion 220 may have a first region S1 in which the opening 230 is positioned along a perimeter thereof, and a second region S2 in which the opening 230 is not positioned. For example, the body portion 220 may be divided into a first region S1 and a second region S2 along the perimeter thereof. Other openings 230 may be disposed at regular intervals between a first opening 230 and a last opening 230. The first region S1 may be a region having the first opening 230 to the last opening 230. In this case, the first region S1 may also include a region positioned between a plurality of openings 230. However, there may be a relatively widest region between the first and last openings 230, and the region may not be included in the first region S1 but may be the second region S2.

The second region S2 may be a region excluding the first region S1. The body portion 220 may have various numbers of first regions S1 and second regions S2. For example, the number of first regions S1 and the number of second regions S2 may be one, respectively. FIG. 8 illustrates one first region S1 and one second region S2. FIGS. 1 to 6 illustrate only a first region S1. Conversely, there may be a plurality of first regions S1 and a plurality of second regions S2. FIG. 9 illustrates two first regions S1 and two second regions S2.

The first region S1 may be disposed to face one of the sides of the case 120. In this case, the opening 230 may be disposed to face a specific direction. For example, the first region S1 may be disposed to face one of the four sides of the case 120. Referring to FIG. 8, the sides of the case 120 may have four sides opposing the X-axis or Y-axis. When the opening 230 is disposed to face a specific direction, the first region S1 may specify the direction in which gas is discharged through the opening 230.

FIG. 10 is a perspective view of another modification of a leakage prevention portion 200b.

Referring to FIG. 10, a leakage prevention layer 210b may be formed as a plate, and an opening 230b may have a porous structure.

The leakage prevention layer 210b may be formed as a plate configured to prevent gas and liquid from passing therethrough. For example, the leakage prevention layer 210b may not have a porous structure. In this case, neither gas nor liquid may pass through the leakage prevention layer 210b. In this case, gas or an electrolyte, discharged from the vent portion 130, may first collide with the leakage prevention layer 210b and then secondarily move toward the opening 230b.

The opening 230b may have a porous structure. The porous structure may be formed to allow gas to pass therethrough but not liquid to pass therethrough. Accordingly, gas, secondarily moving toward the opening 230b, may pass through the porous structure, and may be discharged out of the secondary battery 100. However, an electrolyte may not pass through the porous structure and may collide once again. For example, the opening 230b may include the membrane described above.

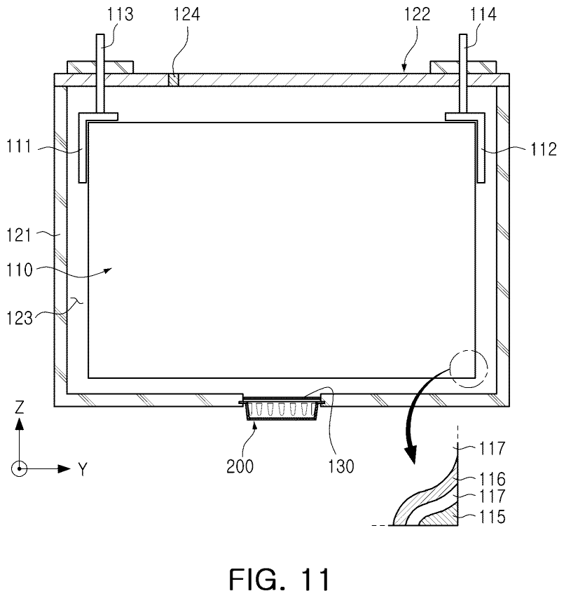

FIG. 11 is a cross-sectional view of a modification of the secondary battery 100 according to the present disclosure.

Referring to FIG. 11, a leakage prevention portion 200 may be positioned on a bottom portion of a case 120.

A plate on which a vent portion 130, on which the leakage prevention portion 200 is positioned, is positioned may be one of all plates of the case 120. FIG. 10 illustrates a case in which the plate on which the vent portion 130 is positioned is positioned on the bottom portion of the case 120. A position of the plate on which the vent portion 130 is positioned is not limited to the position illustrated in the drawings of the present disclosure.

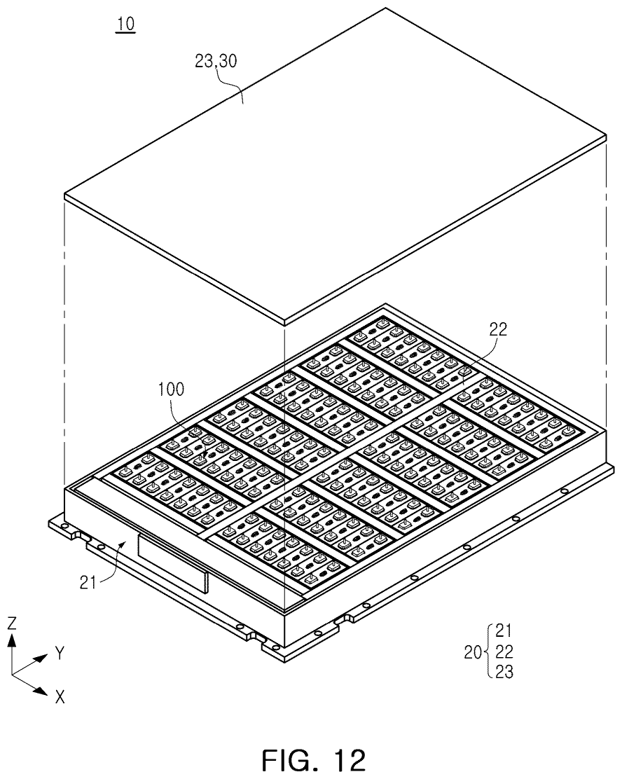

FIG. 12 is a perspective view of a battery module 10 according to the present disclosure.

Referring to FIG. 12 together with FIGS. 1 to 11, the battery module 10 may include a plurality of secondary batteries 100, a housing 20, and a busbar assembly 30. For example, the battery module 10 may include the plurality of secondary batteries 100, the housing 20 accommodating the plurality of secondary batteries 100 and the busbar assembly 30 electrically connecting the plurality of secondary batteries 100 to each other. And the plurality of secondary batteries 100 may include an electrode assembly 110 including a negative electrode plate 115, a positive electrode plate 116, and a separator 117 interposed between the negative electrode plate 115 and the positive electrode plate 116, a case 120 accommodating the electrode assembly 110, a vent portion 130 positioned on a plate disposed on one side of the case 120, and including a notch portion 131 configured to be breakable and a leakage prevention portion 200 disposed further outwardly than the vent portion 130.

The leakage prevention portion 200 coupled to the plate on which the vent portion 130 is positioned, and the leakage prevention portion 200 may include a leakage prevention layer 210 disposed to face the vent portion 130 and a body portion 220 disposed between the leakage prevention layer 210 and the vent portion 130. In addition, the body portion 220 may have an opening 230.

A module referred to herein may be based on a concept including a general module and pack. Accordingly, the battery module 10 may also refer to a battery pack.

The plurality of secondary batteries 100 may be a unit in which a plurality of secondary batteries 100 are aggregated. Each secondary battery 100 may be one of the secondary batteries 100 illustrated in FIGS. 1 to 10.

The housing 20 may accommodate the plurality of secondary batteries 100. To accommodate the plurality of secondary batteries 100, the housing 20 may include a bottom frame 21, a partition wall 22, and a cover 23. The bottom frame 21 may have a space in which the plurality of secondary batteries 100 are accommodated. Frames, positioned on a bottom portion and side surfaces of the module, may be gathered to form the bottom frame 21. The partition wall 22 may be a wall for partitioning an internal space of the bottom frame 21 into several zones. The plurality of secondary batteries 100 may be accommodated in respective spaces partitioned by the partition wall 22. The cover 23 may be coupled to an top portion of the bottom frame 21. The cover 23 may cover the plurality of secondary batteries 100 accommodated in the bottom frame 21.

The busbar assembly 30 may be configured to electrically connect the plurality of secondary batteries 100 to each other. An arrangement and a shape of the busbar assembly 30 are not limited, and the busbar assembly 30 may be a component electrically connecting the plurality of secondary batteries 100 to each other. The busbar assembly 30 may be coupled to the housing 20. For example, the busbar assembly 30 may be in a state of being coupled to the cover 23, opposing electrode terminals of a secondary battery.

Only specific examples of implementations of certain embodiments are described. Variations, improvements and enhancements of the disclosed embodiments and other embodiments may be made based on the disclosure of this patent document.

What is claimed is:

1. A secondary battery comprising:
an electrode assembly including a negative electrode plate, a positive electrode plate, and a separator interposed between the negative electrode plate and the positive electrode plate;
a case accommodating the electrode assembly;
a vent portion positioned on a plate disposed on one side of the case, the vent portion including a notch portion configured to be breakable; and
a leakage prevention portion disposed further outwardly than the vent portion, the leakage prevention portion coupled to the plate on which the vent portion is positioned;
wherein the leakage prevention portion includes:
a leakage prevention layer disposed to face the vent portion; and
a body portion disposed between the leakage prevention layer and the vent portion, the body portion having an opening.

2. The secondary battery of claim 1, wherein the leakage prevention layer has a porous structure.

3. The secondary battery of claim 2, wherein
the leakage prevention layer is disposed to be spaced apart from the vent portion by a first distance in a first direction, and
the first direction is a direction, perpendicular to one surface of the vent portion.

4. The secondary battery of claim 3, wherein a flat section of the leakage prevention layer has an area, equal to or greater than an area of a flat section of the vent portion.

5. The secondary battery of claim 3, wherein
a flat section of the vent portion has an oval shape, and
a flat section of the leakage prevention layer has an oval shape.

6. The secondary battery of claim 5, wherein
the first distance is equal to or greater than half a second distance, and
the second distance is a length of a short axis of the flat section of the vent portion.

7. The secondary battery of claim 1, wherein the leakage prevention layer is configured to allow gas, discharged from the vent portion, to pass therethrough, and to not allow liquid, discharged from the vent portion, to pass therethrough.

8. The secondary battery of claim 1, wherein the body portion has a tube shape.

9. The secondary battery of claim 8, wherein the body portion has a shape gradually widening from the leakage prevention layer to the vent portion.

10. The secondary battery of claim 8, wherein the leakage prevention portion includes a fixing portion protruding along a perimeter of the body portion.

11. The secondary battery of claim 10, wherein the fixing portion is coupled to and fixed to the plate on which the vent portion is positioned.

12. The secondary battery of claim 1, wherein a plurality of openings are disposed along a perimeter of the body portion.

13. The secondary battery of claim 12, wherein the openings are disposed in a distributed manner along the perimeter of the body portion.

14. The secondary battery of claim 12, wherein the body portion has a first region in which the openings are positioned along the perimeter, and a second region in which the openings are not positioned.

15. The secondary battery of claim 14, wherein the first region is disposed to face one of side surfaces of the case.

16. The secondary battery of claim 1, wherein
the leakage prevention layer is formed as a plate configured to prevent gas and liquid from passing therethrough, and
the opening has a porous structure.

17. A battery module comprising:
a plurality of secondary batteries;
a housing accommodating the plurality of secondary batteries; and
a busbar assembly electrically connecting the plurality of secondary batteries to each other,
wherein the plurality of secondary batteries include:
an electrode assembly including a negative electrode plate, a positive electrode plate, and a separator interposed between the negative electrode plate and the positive electrode plate;
a case accommodating the electrode assembly;
a vent portion positioned on a plate disposed on one side of the case, the vent portion including a notch portion configured to be breakable; and
a leakage prevention portion disposed further outwardly than the vent portion, the leakage prevention portion coupled to the plate on which the vent portion is positioned, and
the leakage prevention portion includes:
a leakage prevention layer disposed to face the vent portion; and
a body portion disposed between the leakage prevention layer and the vent portion, the body portion having an opening.
